(19) United States
(12) Patent Application Publication
(10) Pub. No.: US 2026/0268219 A1
(43) Pub. Date: Sep. 10, 2026

(54) SYSTEMS AND METHODS FOR CONFIGURING POWERTRAINS

(71) Applicant: Cummins Inc., Columbus, IN (US)

(72) Inventors: Yong Li, Beijing (CN); Yun Hong, Beijing (CN); Yuchen Yang, Beijing (CN); Xuewei Wang, Beijing (CN); Shiyu Liu, Beijing (CN); Xiaoyan Zhao, Tianjin (CN)

(21) Appl. No.: 19/540,977

(22) Filed: Feb. 16, 2026

(30) Foreign Application Priority Data
Mar. 5, 2025 (CN) 202510256081.X

(51) Int. Cl. G06N 20/00; B60K 6/365; B60K 6/48; B60W 10/06; B60W 10/10; G06F 16/28; G07C 5/00

(52) U.S. Cl. CPC G06N 20/00; B60K 6/365; B60K 6/48; B60W 10/06; B60W 10/10; G06F 16/285; G07C 5/008

(57) ABSTRACT

Systems and methods are provided for selecting a powertrain for a vehicle based on a scenario description for implementing the vehicle. A typical drive cycle for the vehicle based on the scenario is generated from telematics data of other vehicles. For each of a plurality of types of powertrains, a prime mover speed and a prime mover torque are determine based on a vehicle speed and a vehicle power at each work point of the typical drive cycle. The prime mover speed and the prime mover torque at each work point of the typical drive cycles is used to determine a fuel consumption for each gear ratio of the plurality of types powertrains and a gear shift strategy that minimizes the fuel consumption over the typical drive cycle. The powertrain providing the minimum fuel consumption over the typical drive cycle is then selected for the vehicle.

### CROSS-REFERENCE TO RELATED APPLICATION

The present application claims priority to Chinese Patent Application No. 202510256081.X filed on Mar. 5, 2025, which is incorporated herein by reference.

### TECHNICAL FIELD

The present disclosure relates for powertrains for vehicles, and more particularly to systems and methods for configuring powertrains for vehicles.

### BACKGROUND

Vehicle owners select vehicles based on an anticipated scenario for implementing the vehicle, such as the geographic area, route, and application for the vehicle. There can be many different powertrains from which to select that can be installed in the vehicle. Determining which powertrain to select for the vehicle can be hindered by a lack of information about how the vehicle will perform in the anticipated scenario with the various powertrains from which to select. Data that quantifies how the vehicle will perform using the different powertrains would be useful in configuring the vehicle for the anticipated scenario. Therefore, further improvements in this technology area are needed.

### SUMMARY

Embodiments of the present disclosure are directed to apparatuses, devices, hardware, systems, methods, and combinations thereof for a smart configuration of a powertrain for a vehicle. Telematics data from other vehicles and machine learning are leveraged based on a scenario description for an intended use of the vehicle to assess a plurality of different types of powertrains for potential implementation in the vehicle, and for selection of the powertrain from among the assessed powertrains based on gear shifting behavior and fuel economy over a typical drive cycle derived from the telematics data.

Embodiments of systems and methods include selecting a powertrain for a vehicle based on a scenario description of an intended use for implementing the vehicle. In an embodiment, a typical drive cycle for the vehicle based on the scenario description is generated with telematics data from other vehicles. For each of a plurality of different powertrain types, a prime mover speed and a prime mover torque are determined based on a vehicle speed and a vehicle power at each work point of the typical drive cycle. The prime mover speed and the prime mover torque at each work point of the typical drive cycle is used to determine a fuel consumption for each gear ratio of each of the plurality of types of powertrains. A gear shift strategy for each of the plurality of types of powertrains that minimizes fuel consumption over the typical drive cycle is also determined. The powertrain that provides the minimum fuel consumption over the typical drive cycle is then selected for installation in the vehicle from among the plurality of types of powertrains.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a schematic diagram of a vehicle with a powertrain;

FIG. 2 is a simplified block diagram of an embodiment of a process for selecting the powertrain for the vehicle of FIG. 1;

FIG. 3 is an exemplary fuel map used to determine fuel consumption over the typical drive cycle for a plurality of gear ratios for a plurality of powertrains;

FIG. 4 is a simplified block diagram of an exemplary machine learning process implemented in generating a typical drive cycle for use in the powertrain selection process;

FIG. 5 is a graph depicting an exemplary clustering of variables used to generate drive cycles for use in determining the typical drive cycle;

FIG. 6 is a graph showing an exemplary typical drive cycle for the scenario description; and

FIG. 7 is a simplified block diagram of an exemplary system for selecting the powertrain for the vehicle of FIG. 1.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented at least in part as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

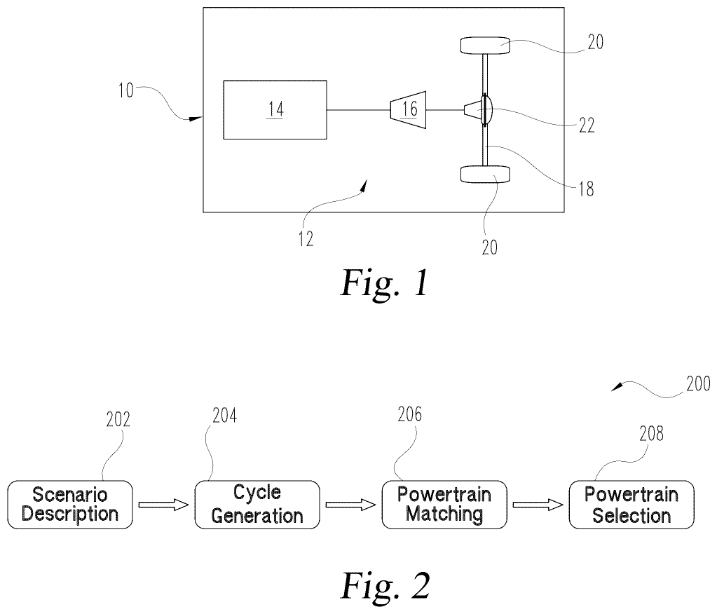

Referring now to FIG. 1, in the illustrative embodiment, an exemplary vehicle 10 including a powertrain 12 is shown. Powertrain 12 may include, for example, one or more of a prime mover 14, a transmission 16, a differential 22, at least one axle 18 such as a rear axle, and one or more grounding engaging wheels or tires 20 coupled to axle 18. Prime mover 14 generates output power that is received by transmission 16. Transmission 16 includes a plurality of gears and is operable to select a gear ratio from among the gears to transfer the output power of prime mover 14 to differential 22, which drives axle 18 at a rear axle ratio, which drives tires 20 to propel vehicle 10 along a route. Vehicle 10 and powertrain 12 may further include other components and features not specifically listed herein, such as one or more additional sets of tires, tracks, multi-axle transmissions, electric axles, and so forth.

Prime mover 14 may be, for example, an internal combustion engine, electric motor, fuel cell, a hybrid application including an engine and electric motor, or other suitable configuration. Prime mover 14 is operable with any suitable fuel, including liquid fuel such as diesel and/or gasoline, gaseous fuel such as hydrogen, natural gas, propane, methane, and combinations of fuels. The gear ratio of transmission 16 can be selected manually, automatically, or semi-automatically. Transmission 16 can include any suitable number of gears from which to select to propel vehicle 10 using two wheel drive, four wheel drive, or other drive arrangement.

A process 200 for configuring powertrain 12 in vehicle 10 is shown with reference to FIG. 2. In an embodiment, process 200 is initiated in response to a customer order or request for a new or refurbished vehicle 10. Process 200 can be performed, for example, by the vehicle manufacturer, powertrain manufacturer, the customer, dealer, re-seller, or combinations of these. Process 200 provides a solution for configuring vehicle 10 with a powertrain 12 that is based on telematics data, fuel maps, and gear shifting optimization for maximum fuel economy. The telematics data can be collected from existing, in-use vehicles with different types of powertrains, from field tests, and/or from modeling, and is used to machine learn a typical drive cycle for vehicle 10 for a scenario description that is provided by the customer.

Process 200 includes a scenario description operation 202 that generates a scenario description of how vehicle 10 will be used. The scenario description can include, for example, a route, an area, and application that is intended for vehicle 10. The area can include, for example, a geographic location for operation of vehicle 10 with climate, temperature, elevation data, and other relevant information. The application for vehicle 10 in the scenario description can include the intended use for vehicle 10. Any application for the scenario description is contemplated, and may include construction applications such as earth-moving, excavating, hauling, mining, etc. that use vehicle 10 with a selected powertrain 12 in the scenario description. Other applications can include shipping of freight such as with trucks, locomotives, and ships; transportation such as for passenger buses, trains, and other passenger vehicles; commercial vehicle; mining equipment; industrial vehicles; and others.

Process 200 continues from operation 202 at cycle generation operation 204 to generate a typical drive cycle from the telematics data collected from operations of vehicles that are already in service and/or are used for field tests. The cycle generation operation 204 includes generating the typical drive cycle for the new vehicle 10 based on the scenario description and from telematics data collected from vehicle and powertrains that are already in service or used for field tests. A drive cycle includes an indication of the timing and duration of vehicle idling, vehicle acceleration, vehicle deceleration, and constant vehicle speed for the scenario description. An embodiment of cycle generation operation 204 is discussed further below with respect to FIGS. 4-6.

Process 200 continues from operation 204 at a powertrain matching operation 206. Powertrain matching operation 206 includes matching a plurality of different types of powertrains 12a, 12b, . . . 12n with the typical drive cycle. For each type of powertrain 12a, 12b, . . . 12n, each of which includes a prime mover 14, transmission 16, axle, 18, and tires 20, the vehicle speed and power demand at each work point of the typical drive cycle is transferred to determine prime mover (engine) speed n and prime mover torque T_{tq} using the following equations:

$$n = \frac{60 * u * {i}_{g} * {i}_{0}}{2 π r} \qquad Equation 1$$

$${P}_{e} = \frac{P}{{η}_{t}} \qquad Equation 2$$

$${T}_{tq} = \frac{9550 * {P}_{e}}{n} \qquad Equation 3$$

In Equations 1-3, P represents vehicle power, Pₑ represents prime mover power, u represents vehicle speed, i_{g} and i₀ represent rear axle ratio and transmission ratio respectively, r represents tire diameter, and nₜ represents transmission efficiency.

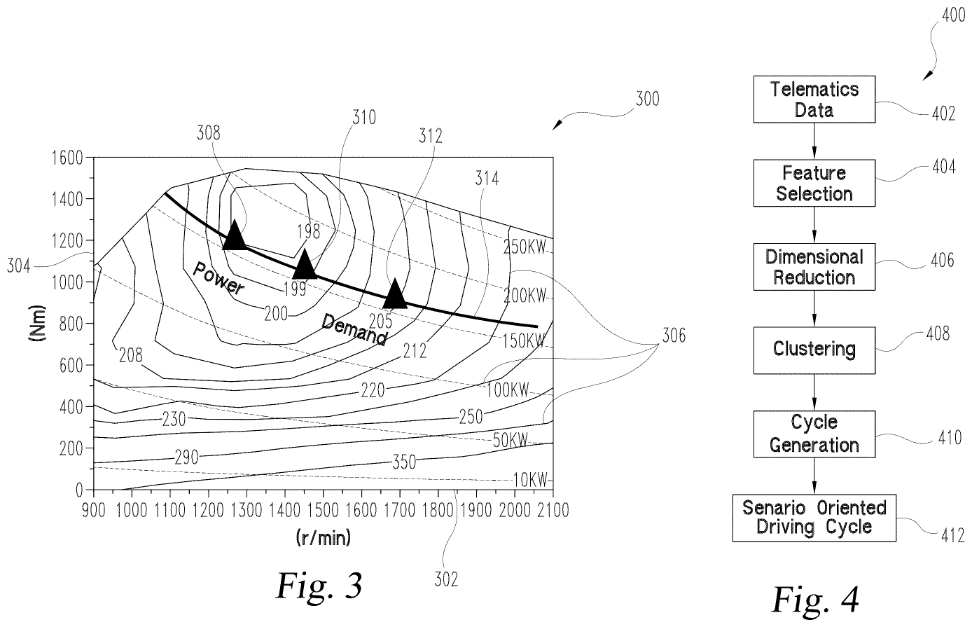

Powertrain matching operation 206 further includes querying fuel consumption at each gear ratio of each of the powertrains 12a, 12b, . . . 12n. In an embodiment, the best fuel economy and its corresponding gear ratio for each of the powertrains 12a, 12b, . . . 12n is determined from a fuel map 300, such as shown in FIG. 3. Fuel map 300 shows prime mover speed 302 along the x-axis, prime mover torque 304 along the y-axis, and contours 306 showing efficiency at various speed versus torque locations. Duty cycle point 308, 310, 312 illustrate efficiency at different gears for each of the powertrains 12a, 12b, . . . 12n along power demand curve 314. An optimal gear shifting strategy I is generated for each powertrain 12a, 12b, . . . 12n considering driving performance and durability, which can be expressed as:

$$I = {arg min}_{i} {F}_{i} \qquad Equation 4$$

In Equation 4, i represents shifting strategy. Therefore, the minimum fuel consumption min Fᵢ under the typical drive cycle is calculated for each of the powertrains 12a, 12b, . . . 12n.

Process 200 continues from operation 206 at powertrain selection operation 208 for selecting the powertrain 12 from among the different types of powertrains 12a, 12b, . . . 12n that will be installed in vehicle 10. Powertrain selection operation 208 includes, for each of the powertrains 12a, 12b, . . . 12n, calculating an optimal powertrain J based on the optimal shift strategy I, which can be expressed as:

$$J = {arg min}_{j} {F}_{I , j} \qquad Equation 5$$

In Equation 5, j represents each considered type of powertrain 12a, 12b, . . . 12n. The vehicle 10 is then configured with the powertrain 12 from among powertrains 12a, 12b, . . . 12n that is determined to be the optimal powertrain J and shifting strategy I to achieve the best fuel economy for the machine learned typical drive cycle under the scenario description for vehicle 10.

An embodiment of cycle generation operation 204 is provided with reference to FIGS. 4-6. FIG. 4 is representative of a machine learning process or algorithm 400 for generating a typical drive cycle for use in selecting the optimized powertrain 12 of vehicle 10, such as via process 200. Process 400 includes an operation 402 to obtain telematics data. The telematics data can be obtained, for example, via field test data and/or via a telematics box (T-box) from a plurality of “test” vehicles that are other vehicles and not vehicle 10. These other vehicles have different types of powertrains 12a, 12b, . . . 12n already or partially in use for which real world telematics data has been collected while operating, modeled, or tested over a plurality of different routes. Examples of real world telematics data include vehicle speed, vehicle acceleration, gear number, prime mover speed, engine speed, engine torque, fuel consumption, driving behavior, and vehicle location from each of the plurality of vehicles over the plurality of routes. Other telematics data is also contemplated and not precluded.

Process 400 continues from operation 402 at a feature selection operation 404. Feature selection operation 404 divides the telematics data in specific scenarios into micro-trips. Kinematics data from the telematics data is used to select kinematic variables that provide a dataset relating to the motion of the other vehicles for each of the micro-trips. The kinematics variables can include, for example, vehicle speed, travel distance, and acceleration for each micro-trip. The kinematic variables of the dataset can include driving force F(t) and power demand P(t), which can be calculated for each micro-trip according to Equations 6 and 7 and included within the datasets for the micro-trips of powertrains 12a, 12b, . . . 12n.

$$F ( t ) = δ m * a ( t ) + \frac{1}{2} {C}_{d} * A * ρ * {v}^{2} ( t ) + m * g * f * cos α + m * g * sin α \qquad Equation 6$$

$$P ( t ) = F ( t ) * ν ( t ) \qquad Equation 7$$

In Equations 6 and 7, 8 represents the conversion coefficient of vehicle rotating mass, m represents vehicle mass; a(t) represents acceleration; C_{d} represents drag coefficient; A represents frontal area; ρ represents air density; v(t) represents vehicle speed; f represents rolling resistance coefficient; g represents the coefficient of gravity; and a represents road grade angle, which is calculated from GPS and altitude information.

Process 400 continues from operation 404 at dimensional reduction operation 406 to dimensionally reduce each of the datasets. The dimensional reduction reduces a number of the plurality of kinematic variables in each of the datasets of the micro-trips while retaining the most important or core data within the datasets.

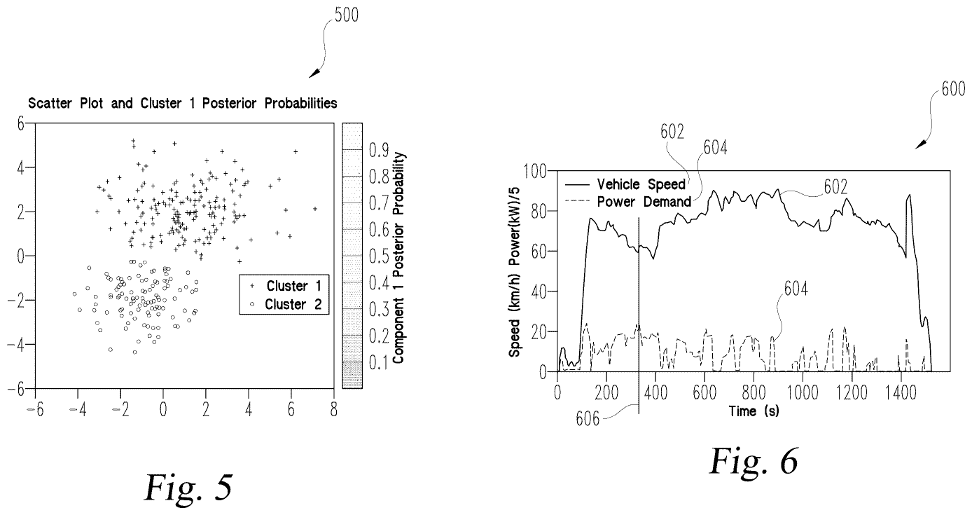

Process 400 continues from dimensional reduction operation 406 at clustering operation 408 to cluster the dimensionally reduced datasets to recognize patterns and groupings for each component of powertrains 12a, 12b, . . . 12n within the dimensionally reduced datasets. An example of clustering of the reduced datasets is shown scatterplot 500 of FIG. 5. In an embodiment, the dimensionally reduced datasets are clustered with unsupervised machine learning. Unsupervised machine learning analyzes unlabeled data that does not include predefined categories or target values to discover patterns and relationships within the data without explicit human guidance. Similar data points are grouped together to identify natural clusters within a dataset. In addition, data points that significantly deviate from the normal pattern can also be identified.

Process 400 continues from operation 408 at a cycle generation operation 410. Cycle generation operation 410 includes generating a plurality of drive cycles from the clustered, dimensionally reduced datasets of the micro-trips. In an embodiment, the driving cycles are generated from the clustered, dimensionally reduced datasets of the micro-trips using a transition probability matrix (TPM) to ensure that time propagation of each cluster remains unchanged in the generated drive cycle. This step is repeated to get a plurality of drive cycles for the scenario description of the vehicle 10.

Operation 400 continues from operation 410 at a scenario-oriented driving cycle operation 412 to generate the typical drive cycle for the vehicle 10 based on the scenario description for vehicle 10 and the telematics data from the other vehicles. An exemplary typical drive cycle is shown in FIG. 6, which includes a graph 600 showing vehicle speed 602 and power demand 604 over time for the scenario description provided for vehicle 10. In an embodiment, operation 412 includes determining a difference between each of the drive cycles generated at operation 410 and the telematics data. Operation 412 also includes selecting the typical drive cycle based on the generated drive cycle having a minimum difference from the telematics data. The vehicle speed 602 and power demand 604 are used at various work points, such as work point 606, along the typical drive cycle at powertrain matching operation 206 as discussed above to determine prime mover (engine) speed n and prime mover torque T_{tq}.

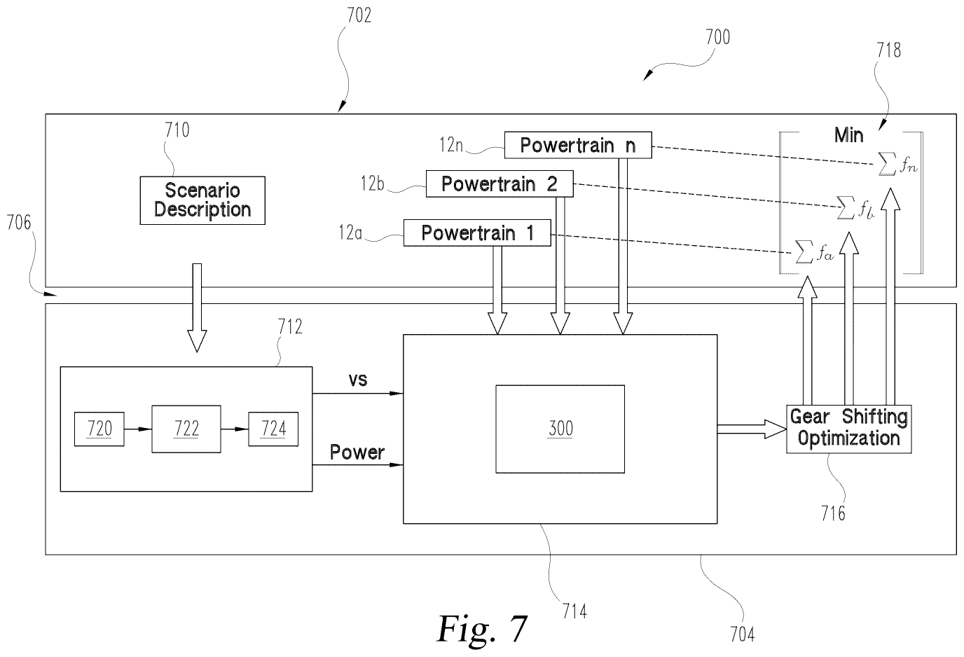

Referring now to FIG. 7, a system 700 is disclosed that is configured to implement processes 200, 400 to select a powertrain 12 for vehicle 10. System 700 includes a user interface 702 and a server 702 connected to user interface 702 via a network 706.

User interface 702 can be a workstation, server, mobile device, tablet, or other computer device configured with one or more applications, portals, algorithms, and/or computer programs that allow input of a scenario description 710 for a vehicle 10 that is to be configured with system 700. The scenario description 710 can, as discussed above, include area, route, and application related information to describe a specific scenario in which vehicle 10 is to be employed.

User interface 702 also stores powertrain data for each of the powertrains 12a, 12b, . . . 12n to be assessed with system 700. In an embodiment, the powertrain data include a prime mover and/or engine platform, the transmission configuration, axle configuration, tire size, and any other powertrain component data that can be used in the assessment. In one form, user interface 702 is a computer device of a programmable variety that executes algorithms and processes data in accordance with operating logic that is defined by programming instructions (such as software or firmware) stored on a memory associated therewith. Alternatively or additionally, operating logic for user interface may be at least partially defined by hardwired logic or other hardware.

Network 706 can include any suitable configuration to connect user interface 702 and server 704. In an embodiment, server 704 is a cloud server. Server 704 communicates with or otherwise receives scenario description 710 and powertrain data for powertrains 12a, 12b, . . . 12n from user interface 702. Server 704 includes a processer and a memory with instructions encoded thereon that cause the processor to determine the typical drive cycle for the scenario description from telematics data. The memory with instructions encoded thereon also cause the processor of server 704 to assess each of the powertrains 12a, 12b, . . . 12n and their respective gear ratios against the typical drive cycle to determine the optimal shift strategy for each powertrain and to select the powertrain with the best fuel economy for installation as powertrain 12 in vehicle 10.

Server 704 includes cycle generation circuit 712 configured to implement process 400 to generate the typical drive cycle. Drive cycle generation circuit 712 can receive telematics data 720 collected from operations of vehicles that are already in service as discussed above with respect to operation 204 and/or process 400. Cycle generation circuit 712 includes machine learning algorithm(s) 722 that process telematics data 720 to generate a typical drive cycle output 724, such as discussed above with respect to FIGS. 4-6.

Cycle generation circuit 712 generates vehicle speed (VS) outputs and power demand (power) outputs at each work point of the typical drive cycle to powertrain matching circuit 714. Powertrain matching circuit 714 determines prime mover (engine) speed n and prime mover torque T_{tq} at each work point of the typical drive cycle, which is used by fuel map 300 in powertrain matching circuit 714 for assessment of gear ratios and efficiency of powertrains 12a, 12b, . . . 12n, such as discussed above for powertrain matching operation 206.

Server 704 further includes a gear shifting optimization circuit 716 and powertrain selection circuit 718. Gear shifting optimization circuit 716 determines optimal gear shifting strategy I for each powertrain 12a, 12b, . . . 12n considering driving performance and durability, such as discussed above and shown in Equation 4. The minimum fuel consumption min Fᵢ under the typical drive cycle is calculated for each of the powertrains 12a, 12b, . . . 12n.

$${min}_{\text{?}} \sum {f}_{i} ( \vec{n} ) \qquad Equation 8$$

In an embodiment, for Equation 8, [symbol] must be 2 or more gear ratios, and if more than 10 gear ratios are present for the powertrain 12a, 12b, . . . 12n the gear ratio must have a duration of more than 60 seconds of use in the typical drive cycle.

Powertrain selection circuit 718 is configured to perform powertrain selection operation 208 for selecting the powertrain 12 to be installed in vehicle 10 from among the different types of powertrains 12a, 12b, . . . 12n. As discussed above, the powertrain selection is based on the optimal powertrain J having the optimal shift strategy I that achieves the best fuel economy, or minimum fuel usage fₐ, f_{b}, . . . fₙ, for the machine learned typical drive cycle under the scenario description for vehicle 10. The selection of the optimal powertrain 12 for vehicle 10 can be provided as an output by user interface 702 as, for example, as a display on a computer screen or touch screen, a printout in hard copy form, an electronic message, an electronic file readable by a computer, an audible output or recording, a computer file, etc.

In an embodiment, the server 704 utilizes any suitable machine learning algorithms to determine the typical drive cycle, including neural network algorithms, instance-based algorithms, regularization algorithms, decision tree algorithms, Bayesian algorithms, clustering algorithms, association rule learning algorithms, deep learning algorithms, dimensionality reduction algorithms, and/or other suitable machine learning and/or predictive algorithms, techniques, and/or mechanisms.

The user interface 702 and/or server 704 and/or network 706 may be embodied as any type of computing network capable of facilitating communication between the various devices of the system 700. As such, these computing devices may include one or more networks, routers, switches, computers, and/or other intervening devices. For example, the server 704 may be embodied as a cloud server or otherwise include one or more cellular networks, telephone networks, local or wide area networks, publicly available global networks (e.g., the Internet), ad hoc networks, short-range communication links, or a combination thereof. In the illustrative embodiment, the server 704 may be configured to process telematics data captured by telematics boxes and/or field tests using artificial intelligence, machine learning, and/or other techniques. In an embodiment, user interface 702 resides all or in part on server 704, but could also reside on a separate server.

It should be further appreciated that the server 704 described herein may function in a cloud computing environment. Server 704 may be embodied as a cloud-based device or collection of devices within a cloud computing environment. Further, in cloud-based embodiments, the server 704 may be embodied as a server-ambiguous computing solution, for example, which executes a plurality of instructions on-demand, contains logic to execute instructions only when prompted by a particular activity/trigger, and does not consume computing resources when not in use. That is, the server 704 may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the server 704 described herein. For example, when an event occurs (e.g., data is transferred to the server 704 for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of telematics data and/or scenario description 710 is made (e.g., via an appropriate user interface to the server 704), the appropriate virtual function(s) may be executed to perform the actions before eliminating the instance of the virtual function(s).

It should be appreciated that each of the user interface 702 and/or server 704 may be embodied as a computing device/system. For example, in the illustrative embodiment, one or more of the user interface 702 and/or server 704 may include a processing device and a memory having stored thereon operating logic for execution by the processing device for operation of the corresponding device.

Depending on the particular embodiment, the user interface 702 and/or server 704 may be embodied as a mobile computing device, server, desktop computer, laptop computer, tablet computer, notebook, netbook, Ultrabook™, cellular phone, smartphone, wearable computing device, personal digital assistant, Internet of Things (IoT) device, control panel, router, gateway, and/or any other computing, processing, and/or communication device capable of performing the functions described herein.

The user interface 702 and/or server 704 includes a processing device that executes algorithms and/or processes data in accordance with operating logic, an input/output device that enables communication between with each other, with one or more external devices, and memory which stores, for example, data received from the one another and/or from one or more external devices via an input/output device.

The input/output device allows the user interface 702 and/or server 704 to communicate with the external device. For example, the input/output device may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Wi-Fi®, WiMAX, etc.) to affect such communication depending on the particular user interface 702 and/or server 704. The input/output device may include hardware, software, and/or firmware suitable for performing the techniques described herein.

The external device may be any type of device that allows data to be inputted or output from the user interface 702 and/or server 704. For example, in various embodiments, the external device may be embodied as the user interface 702 and/or server 704. Further, in some embodiments, the external device may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device may be integrated into the user interface 702 and/or server 704.

The processing device may be embodied as any type of processor(s) capable of performing the functions described herein. In particular, the processing device may be embodied as one or more single or multi-core processors, microcontrollers, or other processor or processing/controlling circuits. For example, in some embodiments, the processing device may include or be embodied as an arithmetic logic unit (ALU), central processing unit (CPU), digital signal processor (DSP), and/or another suitable processor(s). The processing device may be a programmable type, a dedicated hardwired state machine, or a combination thereof. Processing devices with multiple processing units may utilize distributed, pipelined, and/or parallel processing in various embodiments. Further, the processing device may be dedicated to performance of just the operations described herein or may be utilized in one or more additional applications. In the illustrative embodiment, the processing device is of a programmable variety that executes algorithms and/or processes data in accordance with operating logic as defined by programming instructions (such as software or firmware) stored in memory. Additionally, or alternatively, the operating logic for processing device may be at least partially defined by hardwired logic or other hardware. Further, the processing device may include one or more components of any type suitable to process the signals received from input/output device or from other components or devices and to provide desired output signals. Such components may include digital circuitry, analog circuitry, or a combination thereof.

The memory may be of one or more types of non-transitory computer-readable media, such as a solid-state memory, electromagnetic memory, optical memory, or a combination thereof. Furthermore, the memory may be volatile and/or nonvolatile and, in some embodiments, some or all of the memory may be of a portable variety, such as a disk, tape, memory stick, cartridge, and/or other suitable portable memory. In operation, the memory may store various data and software used during operation of the computing device such as operating systems, applications, programs, libraries, and drivers. It should be appreciated that the memory may store data that is manipulated by the operating logic of processing device, such as, for example, data representative of signals received from and/or sent to the input/output device in addition to or in lieu of storing programming instructions defining operating logic. The memory may be included with the processing device and/or coupled to the processing device depending on the particular embodiment. For example, in some embodiments, the processing device, the memory, and/or other components of the user interface 702 and/or server 704 may form a portion of a system-on-a-chip (SoC) and be incorporated on a single integrated circuit chip.

In some embodiments, various components of the user interface 702 and/or server 704 (e.g., the processing device and the memory) may be communicatively coupled via an input/output subsystem, which may be embodied as circuitry and/or components to facilitate input/output operations with the processing device, the memory, and other components of the computing system. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The user interface 702 and/or server 704 may include other or additional components, such as those commonly found in a typical computing device (e.g., various input/output devices and/or other components), in other embodiments. It should be further appreciated that one or more of the components of the user interface 702 and/or server 704 described herein may be distributed across multiple computing devices. In other words, the techniques described herein may be employed by a computing system that includes one or more computing devices.

Various aspect and embodiments are contemplated by the present disclosure. For example, one aspect includes a system for selecting a powertrain configuration for a vehicle. The system includes a server comprising a processor and a memory having a plurality of instructions stored thereon that, in response to execution by the processor. The instructions cause the processor to: receive a scenario description for implementation of the vehicle. The instructions further cause the process to apply a machine learning model configured to generate a typical drive cycle for the scenario description with telematics data that is obtained from a plurality of other vehicles, and, for each of a plurality of different types of powertrains, determine a prime mover speed and a prime mover torque based on a vehicle speed and a power demand, respectively, at each work point of the typical drive cycle. The instructions further cause the processor to determine, based on prime mover speed and the prime mover torque at each work point, a fuel consumption for each gear ratio of the plurality of types of powertrains and a gear shift strategy that minimizes fuel consumption over the typical drive cycle for each of the plurality of types of powertrains; select one of the plurality of types of powertrains having a minimum fuel consumption over the typical drive cycle; and output the powertrain selection for installation in the vehicle.

In an embodiment of the system, the scenario description includes a geographic area, a route, and an application for the vehicle.

In an embodiment of the system, the machine learning model is configured to: divide the telematics data into a plurality of micro-trips; generate a plurality of drive cycles from the plurality of micro-trips; determine a difference between each of the generated drive cycles and the telematics data; and select the typical drive cycle based on the generated drive cycle having a minimum difference from the telematics data.

In an embodiment of the system, the machine learning model is configured to: select a dataset for each micro-trip, each dataset including a plurality of kinematic variables for the associated micro-trip; dimensionally reduce each of the datasets to reduce a number of the plurality of kinematic variables in each of the datasets of the micro-trips; cluster the dimensionally reduced datasets to recognize patterns and groupings within the dimensionally reduced datasets; and generate the plurality of drive cycles from the clustered dimensionally reduced datasets.

In an embodiment of the system, the machine learning model is configured to cluster the reduced datasets with unsupervised machine learning.

In an embodiment of the system, the machine learning model is configured to apply a transition probability matrix to generate the plurality of drive cycles from the dimensionally clustered reduced datasets.

In an embodiment of the system, the machine learning model is configured to determine the fuel consumption and the gear shift strategy that minimizes fuel consumption over the typical drive cycle based on a configuration of a prime mover, a transmission, a rear axle, and a tire for each of the plurality of types of powertrains.

In an embodiment of the system, the fuel consumption for each gear ratio of the plurality of types of powertrains is determined from a fuel consumption map based on the prime mover speed and the prime mover torque.

In an embodiment of the system, the telematics data is real-world telematics data obtained from the plurality of other vehicles operating over a plurality of routes.

In an embodiment of the system, the real-world telematics data includes vehicle speed, vehicle acceleration, gear number, engine speed, engine torque, prime mover speed, fuel consumption, and vehicle location from each of the plurality of vehicles over the plurality of routes.

According to another aspect of the present disclosure, a method for selecting a powertrain configuration for a vehicle is provided. The method includes receiving a scenario description for implementation of the vehicle; generating a typical drive cycle based on the scenario description with telematics data, wherein the telematics data is obtained from a plurality of other vehicles; determining, for each of a plurality of types of powertrains, a prime mover speed and a prime mover torque based on a vehicle speed and a vehicle power at each work point of the typical drive cycle; determining, based on the prime mover speed and the prime mover torque at each work point, a fuel consumption for each gear ratio of the plurality of types of powertrains and a gear shift strategy that minimizes fuel consumption over the typical drive cycle for each of the plurality of types of powertrains; selecting one of the plurality of types of powertrains having a minimum fuel consumption over the typical drive cycle; and installing the powertrain selection in the vehicle.

In an embodiment of the method, the scenario description includes a geographic area, a route, and an application for the vehicle.

In an embodiment, the method includes dividing the telematics data into a plurality of micro-trips; generating a plurality of drive cycles from the plurality of micro-trips; determining a difference between each of the generated drive cycles and the telematics data; and selecting the typical drive cycle based on the generated drive cycle having a minimum difference with the telematics data.

In an embodiment, the method includes selecting a dataset for each of the plurality of micro-trips, each dataset including a plurality of kinematic variables for the associated micro-trip; dimensionally reducing each of the datasets to reduce a number of the plurality of kinematic variables in each of the datasets for the micro-trips; clustering the dimensionally reduced datasets to recognize patterns and groupings within the dimensionally reduced datasets; and generating the plurality of drive cycles from the clustered dimensionally reduced datasets.

In an embodiment of the method, the method includes clustering the reduced datasets with unsupervised machine learning.

In an embodiment, the method includes applying a transition probability matrix to generate the plurality of drive cycles from the clustered dimensionally reduced datasets.

In an embodiment, the method includes determining the fuel consumption and the gear shift strategy that minimizes fuel consumption over the typical drive cycle based on a configuration of a prime mover, a transmission, a rear axle, and a tire for each of the plurality of types of powertrains.

In an embodiment of the method, the fuel consumption for each gear ratio of the plurality of types of powertrains is determined from a fuel consumption map.

In an embodiment of the method, the telematics data is real-world telematics data obtained from the plurality of other vehicles operating over a plurality of routes.

In an embodiment of the method, the real-world telematics data includes vehicle speed, vehicle acceleration, gear number, engine speed, engine torque, prime mover speed, fuel consumption, and vehicle location from each of the plurality of other vehicles over the plurality of routes.

What is claimed is:

1. A system for selecting a powertrain configuration for a vehicle, the system comprising:
a server comprising a processor and a memory having a plurality of instructions stored thereon that, in response to execution by the processor, causes the processor to:
receive a scenario description for implementation of the vehicle;
apply a machine learning model configured to:
generate a typical drive cycle for the scenario description with telematics data, wherein the telematics data is obtained from a plurality of other vehicles;
for each of a plurality of different types of powertrains, determine a prime mover speed and a prime mover torque based on a vehicle speed and a power demand, respectively, at each work point of the typical drive cycle; and
determine, based on prime mover speed and the prime mover torque at each work point, a fuel consumption for each gear ratio of the plurality of types of powertrains and a gear shift strategy that minimizes fuel consumption over the typical drive cycle for each of the plurality of types of powertrains;
select one of the plurality of types of powertrains having a minimum fuel consumption over the typical drive cycle; and
output the powertrain selection for installation in the vehicle.

2. The system of claim 1, wherein the scenario description includes a geographic area, a route, and an application for the vehicle.

3. The system of claim 1, wherein the machine learning model is configured to:
divide the telematics data into a plurality of micro-trips;
generate a plurality of drive cycles from the plurality of micro-trips;
determine a difference between each of the generated drive cycles and the telematics data; and
select the typical drive cycle based on the generated drive cycle having a minimum difference from the telematics data.

4. The system of claim 3, wherein the machine learning model is configured to:
select a dataset for each micro-trip, each dataset including a plurality of kinematic variables for the associated micro-trip;
dimensionally reduce each of the datasets to reduce a number of the plurality of kinematic variables in each of the datasets of the micro-trips;
cluster the dimensionally reduced datasets to recognize patterns and groupings within the dimensionally reduced datasets; and
generate the plurality of drive cycles from the clustered dimensionally reduced datasets.

5. The system of claim 4, wherein the machine learning model is configured to:
cluster the reduced datasets with unsupervised machine learning.

6. The system of claim 4, wherein the machine learning model is configured to:
apply a transition probability matrix to generate the plurality of drive cycles from the dimensionally clustered reduced datasets.

7. The system of claim 1, wherein the machine learning model is configured to:
determine the fuel consumption and the gear shift strategy that minimizes fuel consumption over the typical drive cycle based on a configuration of a prime mover, a transmission, a rear axle, and a tire for each of the plurality of types of powertrains.

8. The system of claim 1, wherein the fuel consumption for each gear ratio of the plurality of types of powertrains is determined from a fuel consumption map based on the prime mover speed and the prime mover torque.

9. The system of claim 1, wherein the telematics data is real-world telematics data obtained from the plurality of other vehicles operating over a plurality of routes.

10. The system of claim 9, wherein the real-world telematics data includes vehicle speed, vehicle acceleration, gear number, engine speed, engine torque, prime mover speed, fuel consumption, and vehicle location from each of the plurality of vehicles over the plurality of routes.

11. A method for selecting a powertrain configuration for a vehicle, the method comprising:
receiving a scenario description for implementation of the vehicle;
generating a typical drive cycle based on the scenario description with telematics data, wherein the telematics data is obtained from a plurality of other vehicles;
determining, for each of a plurality of types of powertrains, a prime mover speed and a prime mover torque based on a vehicle speed and a vehicle power at each work point of the typical drive cycle;
determining, based on the prime mover speed and the prime mover torque at each work point, a fuel consumption for each gear ratio of the plurality of types of powertrains and a gear shift strategy that minimizes fuel consumption over the typical drive cycle for each of the plurality of types of powertrains;
selecting one of the plurality of types of powertrains having a minimum fuel consumption over the typical drive cycle; and
installing the powertrain selection in the vehicle.

12. The method of claim 11, wherein the scenario description includes a geographic area, a route, and an application for the vehicle.

13. The method of claim 11, further comprising:
dividing the telematics data into a plurality of micro-trips;
generating a plurality of drive cycles from the plurality of micro-trips;
determining a difference between each of the generated drive cycles and the telematics data; and
selecting the typical drive cycle based on the generated drive cycle having a minimum difference with the telematics data.

14. The method of claim 13, further comprising:
selecting a dataset for each of the plurality of micro-trips, each dataset including a plurality of kinematic variables for the associated micro-trip;
dimensionally reducing each of the datasets to reduce a number of the plurality of kinematic variables in each of the datasets for the micro-trips;
clustering the dimensionally reduced datasets to recognize patterns and groupings within the dimensionally reduced datasets; and
generating the plurality of drive cycles from the clustered dimensionally reduced datasets.

15. The method of claim 14, further comprising:
clustering the reduced datasets with unsupervised machine learning.

16. The method of claim 14, further comprising:
applying a transition probability matrix to generate the plurality of drive cycles from the clustered dimensionally reduced datasets.

17. The method of claim 11, further comprising:
determining the fuel consumption and the gear shift strategy that minimizes fuel consumption over the typical drive cycle based on a configuration of a prime mover, a transmission, a rear axle, and a tire for each of the plurality of types of powertrains.

18. The method of claim 11, wherein the fuel consumption for each gear ratio of the plurality of types of powertrains is determined from a fuel consumption map.

19. The method of claim 11, wherein the telematics data is real-world telematics data obtained from the plurality of other vehicles operating over a plurality of routes.

20. The method of claim 19, wherein the real-world telematics data includes vehicle speed, vehicle acceleration, gear number, engine speed, engine torque, prime mover speed, fuel consumption, and vehicle location from each of the plurality of other vehicles over the plurality of routes.
